(19) United States
(12) Patent Application Publication
(10) Pub. No.: US 2008/0307448 A1
(43) Pub. Date: Dec. 11, 2008

(54) Optical Disk Device

(75) Inventors: Yoshihiro FUKAGAWA, Yokohama (JP); Shinya Tsubota, Miro (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi- LG Data Storage, Inc.

(21) Appl. No.: 12/129,069

(22) Filed: May 29, 2008

(30) Foreign Application Priority Data
Jun. 5, 2007 (JP) 2007-148848

(51) Int. Cl. G11B 17/028

(52) U.S. Cl. 720/704

(57) ABSTRACT

A restraining element 70 to be inserted into a center hole 102 in an optical disk 100 to restrain movement of the optical disk 100 in its radial direction is placed on a central portion 61 of an optical-disk-facing surface 52 of a rotor casing 53 for a disk motor 50; a supporting element 65 for supporting an optical disk surface 101 of the optical disk 100 is placed on a radially outer portion 62 of the optical-disk-facing surface 52; and flow paths 65A to 65C are provided in the supporting element 65, and extend from the outer circumference of the supporting element 65 to its inner circumference to allow the air inside this optical disk device to flow through.

### CROSS-REFERENCES TO RELATED APPLICATIONS

This application relates to and claims priority from Japanese Patent Application No. 2007-148848, filed on Jun. 5, 2007, the entire disclosure of which is incorporated herein by reference.

### BACKGROUND

1. Field of the Invention

This invention relates to an optical disk device, particularly to an optical disk device having a mechanism capable of realizing uniform internal temperature and pressure distribution.

2. Description of Related Art

As an example of conventional optical disk devices that are ideal for use in stand-alone type electronics (such as personal computers) and mobile electronics (such as notebook personal computers, mobile information terminals and portable video devices), there is an optical disk device including: a cover; a tray provided in the cover so that the tray can be inserted into or ejected from the cover; a disk motor provided in the tray to rotate an optical disk; and a carriage that is held by the tray in such a manner that the carriage can move on the tray, the carriage being capable of moving closer to or away from the disk motor and being equipped with an optical unit for recording and/or reproducing information on/from the optical disk. In this optical disk device, holes or recesses are formed in part of a rotor provided in the disk motor to achieve weight reduction (see, for example, Japanese Patent Application Laid-Open (Kokai) Publication No. 2005-327413).

There is another type of optical disk device that has through-holes in a rotor casing, and a disk holding element for supporting a plane portion of an optical disk and restraining movement of the optical disk in its radial direction, so that during rotation of the optical disk the air inside the optical disk device passes through the through-holes, thereby preventing negative pressure at and around the center of the optical disk and reducing any temperature difference between the front and back sides of the optical disk (see, for example, Japanese Patent Application Laid-Open (Kokai) Publication No. 2004-326992 and Japanese Patent Application Laid-Open (Kokai) Publication No. 2006-99832).

When an optical disk is rotated in an optical disk device, a pressure difference generally develops between the central portion of the optical disk and its radially outer portion, and this pressure difference causes the optical disk and the disk motor to be drawn to and thereby lean to the top casing side where negative pressure develops; and as a result, there is a possibility that the performance of an optical pickup to read recorded information might deteriorate. Moreover, due to the pressure difference described above, the optical disk may possibly come loose if the optical disk device undergoes any physical impact during operation. Furthermore, because heat sources such as the optical pickup, laser drive circuit, and disk motor are placed only on one side of the optical disk, that side of the optical disk heats up and, therefore, a temperature difference develops between the two sides of the optical disk, which might change the shape of the optical disk and also deteriorate recorded information reading performance. These problems occur particularly with slim-type optical disk devices having thicknesses of, for example, 12.7 mm or 9.5 mm.

### SUMMARY

With the optical disk device disclosed in Japanese Patent Application Laid-Open (Kokai) Publication No. 2005-327413, heat flow paths are provided by forming holes or recesses in part of the rotor in the disk motor so that the heat generated in the optical disk device passes through the holes or the recesses by means of the rotation of the rotor. As a result, thermal diffusion can be achieved and a temperature rise in the optical disk device can be thereby prevented. However, no consideration has been made for increasing the reliability in recording/reproduction by eliminating the pressure difference between the central portion and the radially outer portion of the optical disk, or preventing the optical disk from coming loose if the optical disk device undergoes any physical impact during operation. Moreover, in the optical disk device disclosed in Japanese Patent Application Laid-Open (Kokai) Publication No. 2005-327413, the holes or recesses are formed close to the disk motor. Therefore, there is a possibility that oil from the disk motor might leak via the holes or recesses and adhere to the optical disk or the optical disk device.

Meanwhile, also in the optical disk devices disclosed in Japanese Patent Application Laid-Open (Kokai) Publication No. 2004-326992 and Japanese Patent Application Laid-Open (Kokai) Publication No. 2006-99832, because through-holes are formed close to a bearing that supports a drive shaft for the disk motor, there is a possibility that lubricating oils in the bearing might leak via the through-holes and adhere to the optical disk and the optical disk device.

This invention was devised in view of the circumstances described above. It is an object of the invention to provide an optical disk device capable of not only realizing uniform temperature and pressure distribution in the optical disk device, but also preventing oils or lubricating oils used in a disk motor, a bearing, and other components placed inside the device from leaking within the optical disk device and adhering to the optical disk or the optical disk device.

In order to achieve the above object, according to an aspect of the invention, an optical disk device having a disk motor for rotating an optical disk on which information is recorded or from which information is reproduced is provided. In this optical disk device, the disk motor has a rotor located so as to be concentric with the optical disk rotated by the disk motor; the rotor includes a rotor casing having an optical-disk-facing surface opposite an optical disk surface of the optical disk rotated by the disk motor; a restraining element to be inserted into a center hole in the optical disk for restraining movement of the optical disk in its radial direction is located on a central portion of the optical-disk-facing surface and a supporting element for supporting the optical disk surface is placed on a radially outer portion of the optical-disk-facing surface; the supporting element has at least one flow path extending from the outer circumference of the supporting element to its inner circumference to allow the air inside the optical disk device to flow through; and the restraining element has at least one through-hole connected to the flow path, and at least one flow hole for allowing the air to flow between the inside and outside of the restraining element.

According to another aspect of the invention, an optical disk device having a disk motor for rotating an optical disk on which information is recorded or from which information is reproduced is provided. In this optical disk device, the disk motor has a rotor located so as to be concentric with the optical disk rotated by the disk motor; the rotor includes a rotor casing having an optical-disk-facing surface opposite an optical disk surface of the optical disk rotated by the disk motor; a restraining element to be inserted into a center hole in the optical disk for restraining movement of the optical disk in its radial direction is located on a central portion of the optical-disk-facing surface and a supporting element for supporting the optical disk surface is placed on a radially outer portion of the optical-disk-facing surface; the rotor casing has, on the optical-disk-facing surface, at least one first flow path extending from the outer circumference of the rotor casing to the restraining element to allow the air inside the optical disk device to flow through; and the restraining element has at least one through-hole connected to the first flow path, and at least one flow hole for allowing the air to flow between the inside and outside of the restraining element.

### BRIEF DESCRIPTION OF THE DRAWINGS

FIG. 1 is an exploded perspective view of an optical disk device according to Embodiment 1 of the invention.

FIG. 2 is a perspective view of the main part of the optical disk device shown in FIG. 1.

FIG. 3 is a plan view of the main part shown in FIG. 2.

FIG. 4 is a cross-sectional view of the main part taken along line IV-IV in FIG. 3.

FIG. 5 is a cross-sectional view of the main part taken along line IV-IV line in FIG. 3, showing the state where an optical disk is set in the optical disk device shown in FIG. 1.

FIG. 6 is a perspective view of the main part of an optical disk device according to another embodiment of the invention.

FIG. 7 is a plan view of the main part shown in FIG. 6.

FIG. 8 is a perspective view of the main part of an optical disk device according to another embodiment of the invention.

FIG. 9 is a plan view of the main part shown in FIG. 8.

FIG. 10 is a perspective view of the main part of an optical disk device according to Embodiment 2 of the invention.

FIG. 11 is a plan view of the main part shown in FIG. 10.

FIG. 12 is a perspective view of the main part of an optical disk device according to another embodiment of the invention.

FIG. 13 is a plan view of the main part shown in FIG. 12.

FIG. 14 is a plan view showing the main part of an optical disk device according to another embodiment of the invention.

FIG. 15 is an exploded perspective view of an optical disk device according to another embodiment of the invention.

### DETAILED DESCRIPTION OF PREFERRED EMBODIMENTS

Optical disk devices according to preferred embodiments of the invention will be explained below with reference to the attached drawings. The embodiments described below are for the purpose of describing this invention, but the invention is not limited only to these embodiments. Accordingly, this invention can be utilized in various ways unless the utilizations depart from the gist of the invention.

### Embodiment 1

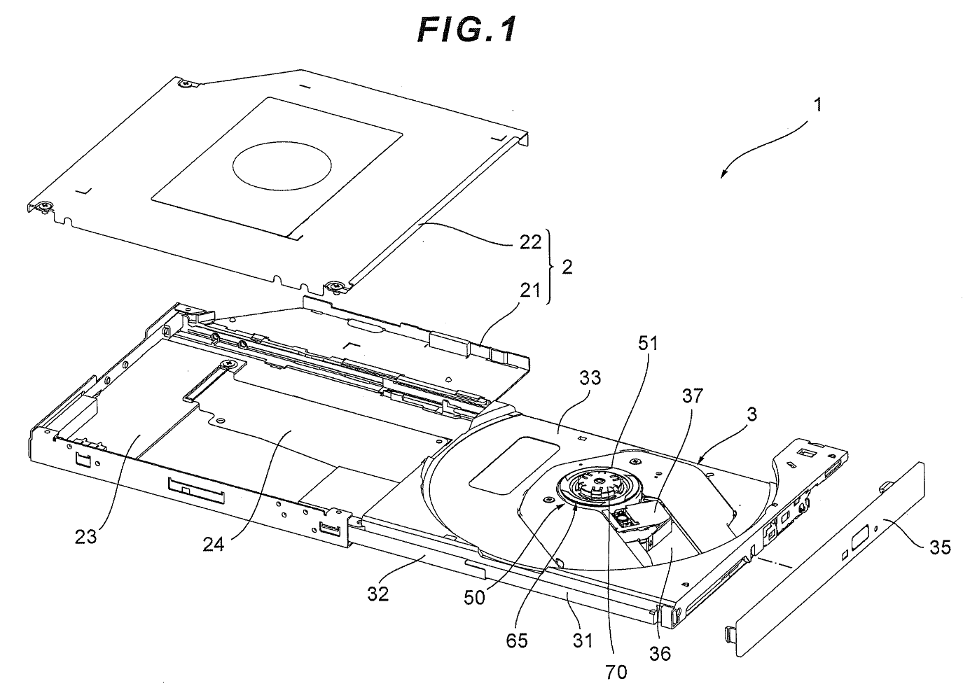

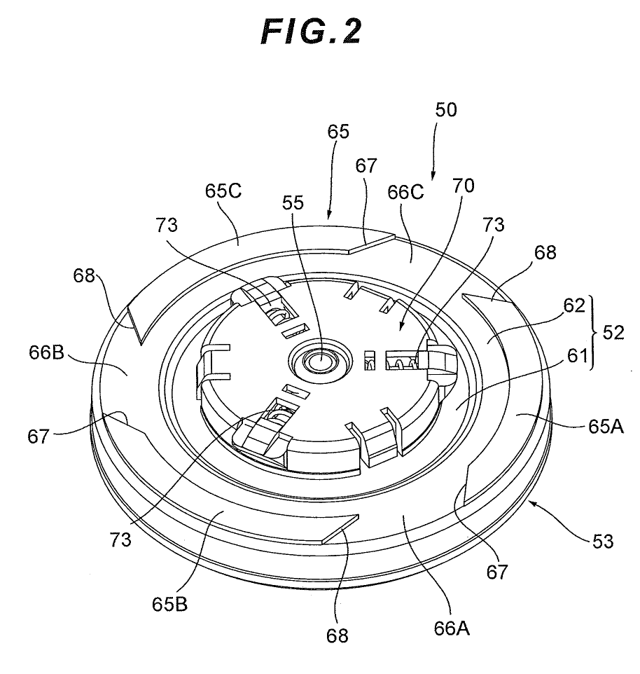

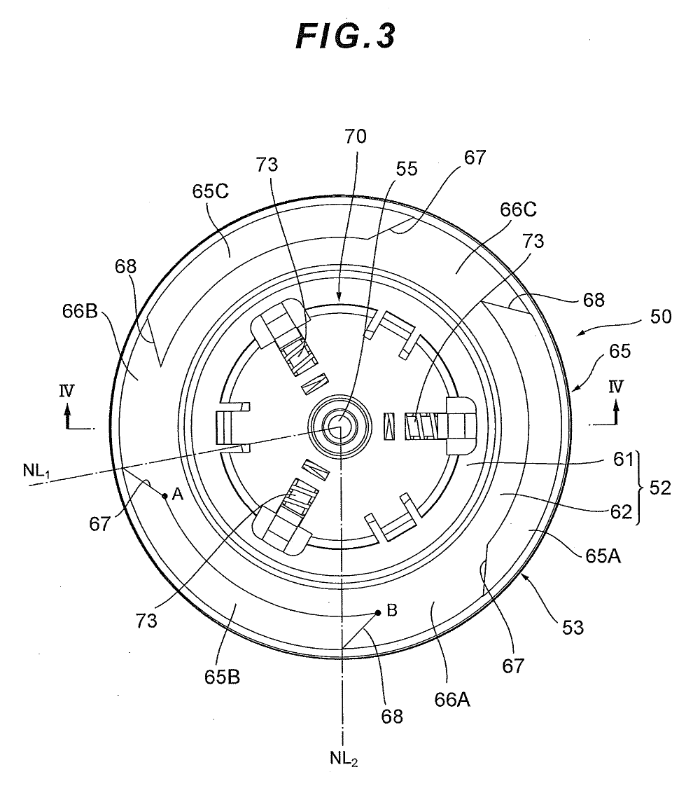

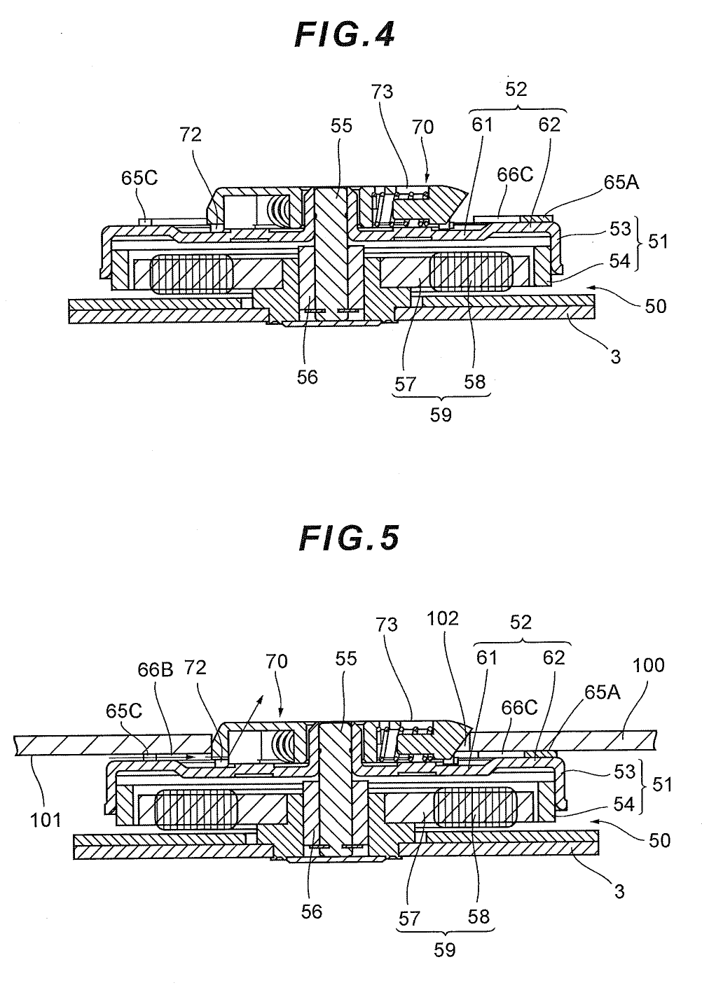

FIG. 1 is an exploded perspective view of an optical disk device according to Embodiment 1 of the invention; FIG. 2 is a perspective view showing the main part of the optical disk device shown in FIG. 1; FIG. 3 is a plan view of the main part shown in FIG. 2; FIG. 4 is a cross-sectional view of the main part taken along line IV-IV in FIG. 3; and FIG. 5 is a cross-sectional view of the main part taken along line IV-IV shown in FIG. 3, showing the state where an optical disk is set in the optical disk device shown in FIG. 1.

In these drawings, for ease of explanation, the thickness, size, and enlargement/reduction scale of some elements do not correspond to those of the actual elements. Explanations below are premised on the optical disk device according to Embodiment 1 rotating an optical disk placed therein in a clockwise direction.

As shown in FIGS. 1-5, an optical disk device 1 according to Embodiment 1 has a housing 2 and a tray 3 placed in the housing 2 so that the tray 3 can be inserted into or ejected from the housing 2. The housing 2 is of a box shape composed of a bottom casing 21 and a top casing 22 placed on the bottom casing 21, and is structured so that the tray 3 is inserted into or ejected from an opening in the housing 2. It should be noted that the housing 2 used in Embodiment 1 is 9.5 mm thick (i.e., thickness in a direction generally perpendicular to the optical disk surface 101 of an optical disk 100 rotated by a disk motor 50).

The bottom casing 21 includes: a circuit board 23 equipped with a laser drive circuit (not shown in the drawing) for driving a laser diode (not shown in the drawing) placed in a optical pickup 37 (described later); and a motor drive circuit (not shown in the drawing) for driving a disk motor 50 (described later). The bottom casing 21 is also equipped with a flexible board 24 for connection.

The tray 3 has an optical-disk-mounting portion 33 formed to be facing one side of the optical disk 100 when accepting the optical disk 100 (see FIG. 5). Part of the outer circumference of the optical-disk-mounting portion 33 is of a generally semicircular shape corresponding to the shape of the optical disk 100. The optical-disk-mounting portion 33 has an opening 36, through which the optical pickup 37 is partially exposed. A guide rail 31 is provided on each side of the tray 3 along the direction of insertion/ejection of the tray 3. A moving rail 32 that moves along the guide rail 31 is mounted on each guide rail 31. A bezel 35 is placed on the front end face of the tray 3 to close the opening of the housing 2.

The disk motor 50 is provided at a position corresponding to the approximate center of the optical-disk-mounting portion 33. The disk motor 50 has a rotor 51 located so as to be concentric with the optical disk 100 placed on the optical-disk-mounting portion 33. The rotor 51 includes: a rotor casing 53 having an optical-disk-facing surface 52 opposite the optical disk surface 101 (see FIG. 5) of the optical disk 100 placed on the optical-disk-mounting portion 33; and a rotor magnet 54 placed on the inner wall of the rotor casing 53. A drive shaft 55 for the disk motor 50 is placed on the central portion of the rotor casing 53. This drive shaft 55 is supported by a bearing 56. A stator 59 having a stator core 57 and a stator coil 58 is also placed in the rotor casing 53. The rotor 51 is structured so that it rotates when the stator coil 58 in the stator 59 receives a drive current from a motor drive circuit (not shown in the drawing).

The optical-disk-facing surface 52 of the rotor casing 53 includes: a central portion 61 through which the drive shaft 55 passes, and on which a restraining element 70 (described later) is placed; and a radially outer portion 62 that is formed connected to the central portion 61 and raised above the central portion 61. A supporting element 65 (e.g., turntable sheet) for supporting the optical disk 100 by contact with the optical disk surface 101 of the optical disk 100 is placed on the radially outer portion 62 of the rotor casing 53. This supporting element 65 has a specified thickness and is composed of three support sections 65A to 65C formed by circumferentially dividing the supporting element 65 into three equal sections. These support sections 65A to 65C are separated from one another to form gaps of generally the same shape between the adjacent support sections, i.e., between support section 65A and support section 65B, between support section 65B and support section 65C, and between support section 65C and support section 65A, respectively. These gaps extend through the supporting element 65 from its outer circumference to the inner circumference and serve as flow paths 66A, 66B and 66C to allow the air inside the optical disk device 1 to flow through. As described above, the flow paths 66A, 66B and 66C can be formed by a simple step of dividing the supporting element 65 into separate sections.

The side walls 67 and 68 of each support section 65A to 65C that extend inwards from the outer circumference define each flow path 66A, 66B, 66C. Of the side walls 67 and 68 of each support section 65A to 65C, the side wall 67 is located ahead of the side wall 68 relative to the rotational direction of the rotor 51 and inclined relative to a normal line NL₁ (see FIG. 3)—passing through the outer circumferential edge of the side wall 67—so that the inner circumferential edge A of the side wall 67 (see FIG. 3) is positioned behind the normal line NL₁ relative to the rotational direction of the rotor 51. The side wall 67 is slightly curved inwards (i.e., is curved toward the rear side relative to the rotational direction of the rotor 51). Meanwhile, the side wall 68 located behind the side wall 67 relative to the rotational direction of the rotor 51 is inclined relative to a normal line NL₂ (see FIG. 3)—passing through the outer circumferential edge of the side wall 68—so that the inner circumferential edge B of the side wall 68 (see FIG. 3) is positioned behind the normal line NL₂ relative to the rotational direction of the rotor 51. The side wall 68 is slightly curved outwards (i.e., protrudes toward the rear side relative to the rotational direction of the rotor 51). Since the side walls 67 and 68 have the above-described shapes, when the rotor 51 rotates, the air inside the optical disk device 1 can efficiently flow (be drawn) to the central portion of the optical disk 100 through the flow paths 66A, 66B and 66C.

A restraining element 70 (e.g., clamper), which is to be inserted into the center hole 102 (see FIG. 5) of the optical disk 100 to restrain movement of the optical disk 100 in its radial direction, is placed on the central portion of the optical-disk-facing surface 52. This restraining element 70 protrudes from the disk motor 50 towards the top casing 22 side and fits the center hole 102 of the optical disk 100, thereby chucking the optical disk 100. A plurality of through-holes 72 (see FIGS. 4 and 5) are formed in the end portion of the restraining element 70 on the optical-disk-facing surface 52 side, to introduce the air passing through the flow paths 66A, 66B and 66C into the inside of the restraining element 70. Meanwhile, on the top casing 22 side of the restraining element 70, a plurality of flow holes 73 are formed to allow the air to flow between the inside and outside of the restraining element 70 (in Embodiment 1, the air inside the restraining element 70 is discharged from the restraining element 70 through the flow holes 73 to the outside). Holes previously formed in the restraining element 70 may be used as the through-holes 72 and flow holes 73, or they may be formed separately.

Specific operation of the optical disk device 1 according to Embodiment 1 will be explained below. First, the tray 3 is ejected from the housing 2 and an optical disk 100 is placed on the optical-disk-mounting portion 33, and the restraining element 70 is made to fit into the center hole 102 of the optical disk 100. In this way, the optical disk 100 is chucked by the restraining element 70 and the optical disk surface 101 comes into contact with and is supported by the support sections 65A to 65C so that it will not slip. The tray 3 is then inserted into the housing 2.

When a drive current is supplied to the stator coil 58 of the stator 59 in the disk motor 50 and the rotor 51 rotates, the support sections 65A to 65C, restraining element 70, and the optical disk 100 supported by these parts rotate. By the rotation of the optical disk 100, the air on the top casing 22 side surface of the optical disk 100 flows from the central portion of the optical disk 100 to its radially outer portion. Meanwhile, the air on the optical disk surface 101 side of the optical disk 100 is drawn, via the flow paths 66A, 66B and 66C, from the outer circumference of the support sections 65A to 65C to their inner circumference, as shown with an arrow in FIG. 5. When this happens, because the side walls 67 and 68 of each support section 65A to 65C are formed as curved and inclined faces as described above, the air can be efficiently introduced to the central portion of the optical disk 100.

The air then reaches the restraining element 70, enters the restraining element 70 from the through-holes 72 formed in the restraining element 70, passes (flows) through the inside of the restraining element 70, and then exits the restraining element 70 from the flow holes 73.

As explained above, a flow of air is formed in the optical disk device 1 as follows: the air on the top casing 22 side of the optical disk 100 flows from the central portion of the optical disk 100 to its radially outer portion; passes through the space between the optical disk surface 101 of the optical disk 100 and the optical-disk-facing surface 52 of the rotor casing 53; enters the flow paths 66A, 66B, and 66C; reaches the restraining element 70 via the flow paths 66A, 66B, and 66C; passes through the inside of the restraining element 70; exits the restraining element 70 via the flow holes 73; and then returns to the top casing 22 side of the optical disk 100. This flow of air efficiently reduces the pressure difference between the inner surface of the top casing 22 and the optical disk 100 as well as between the central portion of the optical disk 100 and its radially outer portion, and also reliably prevents generation of a temperature difference between the top surface and the bottom surface of the optical disk 100. As a result, even if a slim-type optical disk device 1 is used that has a thickness between 5 mm and 15 mm inclusive and can easily generate a pressure difference or temperature difference within the optical disk device 1 when an optical disk 100 rotates, it is possible to realize uniform temperature and pressure distribution inside the optical disk device 1 and prevent the occurrence of trouble such as tilt or deformation of the optical disk 100.

Moreover, because the flow paths 66A, 66B, and 66C are the gaps between the support sections 65A to 65C placed on the optical-disk-facing surface 52 of the rotor casing 53, the above-described flow of air will not pass through the inside of the rotor casing 53. As a result, the lubricating oil used in the bearing 56 placed inside the rotor casing 53 and the oil used in the disk motor 50 will not leak through the flow paths 66A, 66B, and 66C into the optical disk device 1.

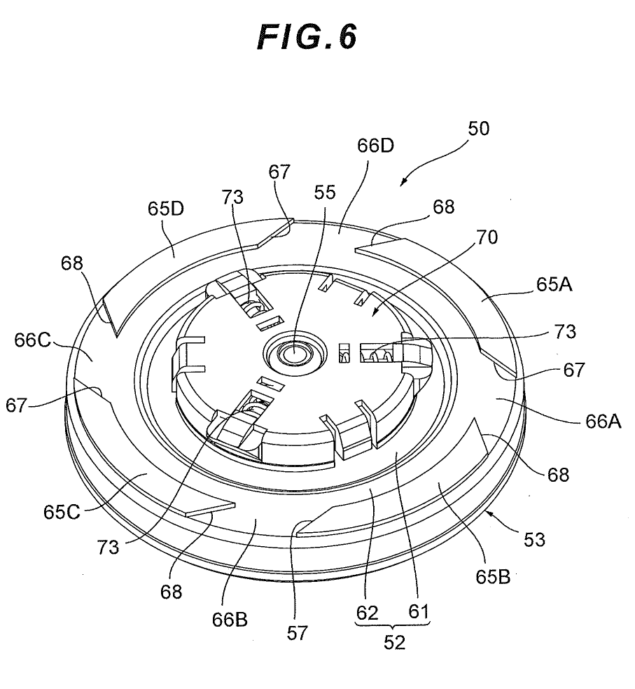

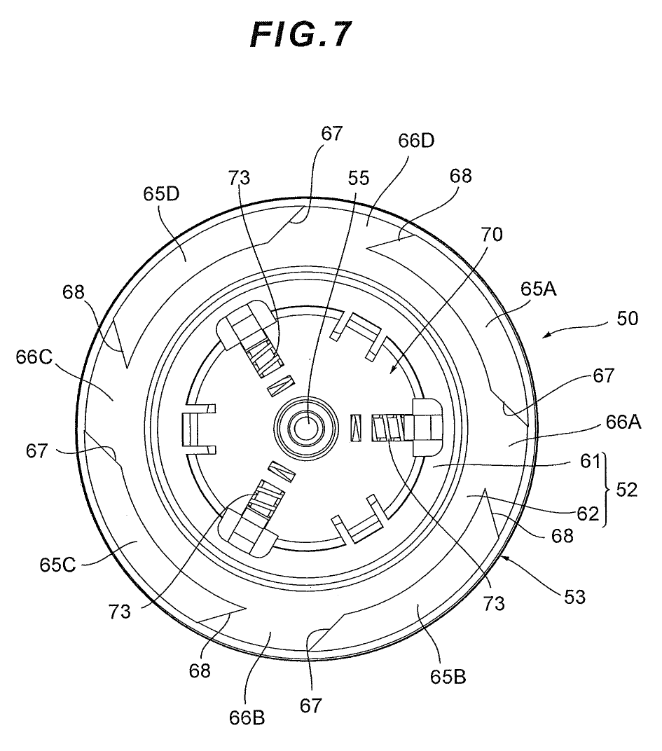

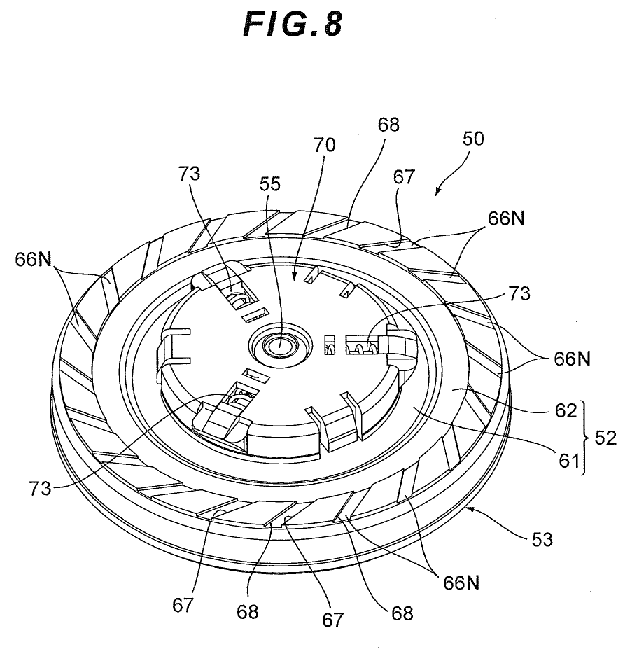

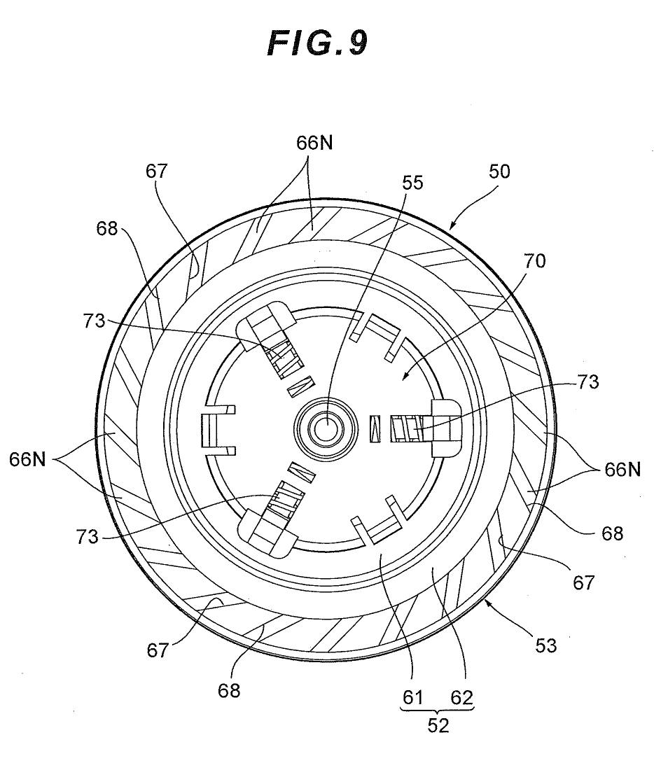

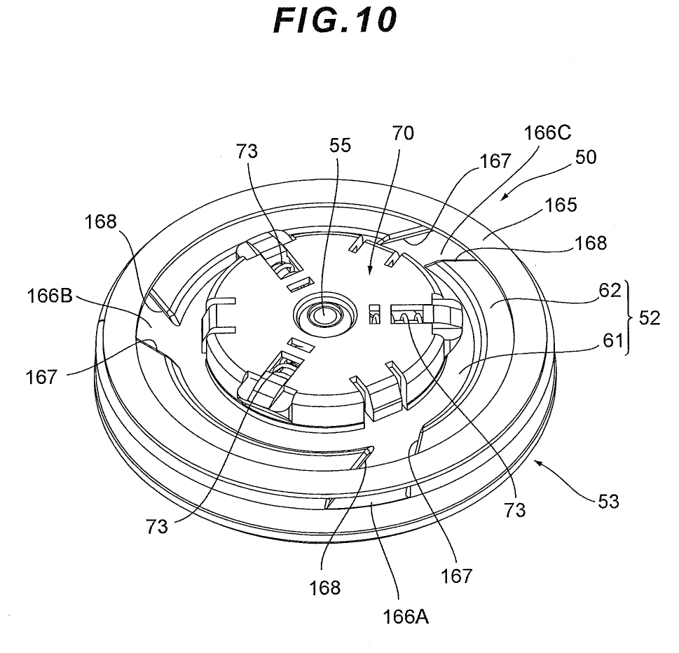

Embodiment 1 describes the case where the supporting element 65 is divided into three parts to form the three flow paths 66A, 66B, and 66C. However, the invention is not limited to this example, and the supporting element 65 may be divided into sections at any specified positions along the circumference. For example, as shown in FIGS. 6 and 7, the supporting element 65 may be divided into four equal parts to form four support sections 65A to 65D, thereby forming four flow paths 66A to 66D. Alternatively, as shown in FIGS. 8 and 9, the supporting element 65 may be divided into five or more sections, thereby forming five or more flow paths 66N. There may be any number of flow paths, even just one will do, as long as they extend from the outer circumference of the supporting element 65 to its inner circumference and allow the air inside the optical disk device 1 to flow through. If desired, the size of the flow paths may be arbitrarily determined, as long as the original function of the supporting element 65, i.e., the function supporting the optical disk 100 placed thereon and preventing displacement of the optical disk 100 to ensure its proper rotation with the rotor 51, will not be impaired. Furthermore, the supporting element 65 is not necessarily divided into equal parts and division positions may be determined arbitrarily.

Embodiment 1 also describes the case where the side wall 67 of each support section 65A to 65C is inclined relative to the normal line NL₁ and curved, while the side wall 68 is inclined relative to the normal line NL₂ and curved. However, the invention is not limited to this example, and the side walls 67 and 68 may be flat, not curved, and inclined relative to the normal lines NL₁ and NL₂. The shape of the flow paths is not particularly limited as long as each flow path extends from the outer circumference of the supporting element 65 towards its inner circumference and allows the air to flow through.

Furthermore, Embodiment 1 describes an optical disk device 1 that is 9.5 mm thick. However, the invention is not limited to this example, and any slim-type optical disk device with a thickness between 5 mm and 15 mm inclusive (e.g., an optical disk device with thickness of 12.7 mm) or any optical disk device with thickness outside the above-mentioned range may be used.

### Embodiment 2

An optical disk device according to Embodiment 2 of the invention will be explained below with reference to the relevant drawings. The elements used in Embodiment 2 the same as those explained in Embodiment 1 are given the same reference numerals as in Embodiment 1, and any detailed description of them has been omitted.

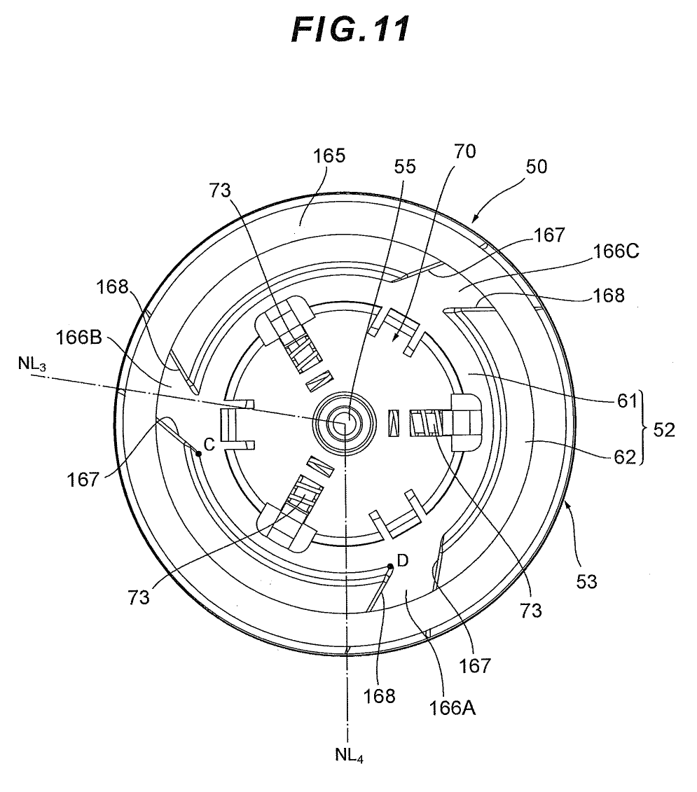

FIG. 10 is a perspective view of the main part of an optical disk device according to Embodiment 2; and FIG. 11 is a plan view of the main part shown in FIG. 10.

As shown in FIGS. 10 and 11, the main difference between the optical disk device according to Embodiment 2 and the optical disk device 1 according to Embodiment 1 is that flow paths 166A to 166C are formed on the optical-disk-facing surface 52 of the rotor casing 53 and a ring-shaped supporting element 165 is placed on the radially outer portion 62 of the optical-disk-facing surface 52.

More specifically, recesses are formed at respective positions 120° apart from each other along the circumferential direction of the optical-disk-facing surface 52; and each recess extends through the radially outer portion 62 of the optical-disk-facing surface 52 from its outer circumference to its inner circumference and is connected to the central portion 61 of the optical-disk-facing surface 52. These three recesses are formed so that their bottom surfaces are at the same level as (lies in the same plane with) and connected to the central portion 61 of the optical-disk-facing surface 52. These three recesses serve as flow paths 166A, 166B, and 166C that allow the air inside the optical disk device to flow through. As described above, the flow paths 166A, 166B, and 166C can be formed by a simple step of forming recesses in the radially outer portion 62 of the optical-disk-facing surface 52.

Of the side walls 167 and 168 defining the two sides of each flow path (i.e., recess) 166A to 166C that extend inwards from the outer circumference of the rotor casing 53, the side wall 167 located ahead of the side wall 168 relative to the rotational direction of the rotor 51 is inclined relative to a normal line NL₃ (see FIG. 11)—passing through the outer circumferential edge of the side wall 167—so that the inner circumferential edge C of the side wall 167 (see FIG. 11) is positioned behind the normal line NL₃ relative to the rotational direction of the rotor 51. The side wall 167 is slightly curved inwards (i.e., is curved toward the rear side relative to the rotational direction of the rotor 51). Meanwhile, the side wall 168 located behind the side wall 167 relative to the rotational direction of the rotor 51 is inclined relative to a normal line NL₄ (see FIG. 11)—passing through the outer circumferential edge of the side wall 168—so that the inner circumferential edge D of the side wall 168 (see FIG. 11) is positioned behind the normal line NL₄ relative to the rotational direction of the rotor 51. The side wall 168 is slightly curved outwards (i.e., protrudes toward the rear side relative to the rotational direction of the rotor 51). Since the side walls 167 and 168 have the above-described shapes, when the rotor 51 rotates, the air inside the optical disk device 1 can efficiently flow (be drawn) to the central portion of the optical disk 100 through the flow paths 166A, 166B and 166C.

The supporting element 165 for supporting the optical disk 100 by contact with the optical disk surface 101 of the optical disk 100 is placed on the radially outer portion 62 where the flow paths 166A, 166B and 166C are formed.

Specific operation of the optical disk device according to Embodiment 2 will be explained below. First, just as in Embodiment 1, when the optical disk 100 placed in the optical disk device rotates, the air on the top casing 22 side surface of the optical disk 100 flows from the central portion of the optical disk 100 to its radially outer portion. Meanwhile, the air on the optical disk surface 101 side of the optical disk 100 is drawn, via the flow paths 166A, 166B, and 166C, from the outer circumference of the optical-disk-facing surface 52 of the rotor casing 53 to its inner circumference When this happens, because the side walls 167 and 168 of each flow path 166A, 166B, and 166C that extend inwards from the outer circumference are formed as curved and inclined faces as described above, the air can be efficiently introduced to the central portion of the optical disk 100.

Subsequently, the air reaches the central portion of the optical-disk-facing surface 52 and then reaches the restraining element 70. Just as in Embodiment 1, the air then enters the restraining element 70 from the through-holes 72 formed in the restraining element 70, passes (flows) through the inside of the restraining element 70, and then exits the restraining element 70 through the flow holes 73.

As explained above, a flow of air is formed in the optical disk device as follows: the air on the top casing 22 side surface of the optical disk 100 flows from the central portion of the optical disk 100 to the radially outer portion; enters the flow paths 166A, 166B, and 166C; reaches the restraining element 70; passes through the inside of the restraining element 70; exits the restraining element 70 from the flow holes 73; and then returns to the top casing 22 side surface of the optical disk 100. Just as in Embodiment 1, this flow of air efficiently reduces the pressure difference between the inner surface of the top casing 22 and the optical disk 100 as well as between the central portion side of the optical disk 100 and its radially outer portion side, and also reliably prevents generation of a temperature difference between the top surface and the bottom surface of the optical disk 100. As a result, even if a slim-type optical disk device 1 is used that has a thickness between 5 mm and 15 mm inclusive and can easily generate a pressure difference or temperature difference within the optical disk device 1 when an optical disk 100 rotates, it is possible to realize uniform temperature and pressure distribution inside the optical disk device and prevent the occurrence of trouble such as tilting or deformation of the optical disk 100.

Moreover, because the flow paths 166A, 166B, and 166C are recesses formed in the optical-disk-facing surface 52 of the rotor casing 53, the air will not pass through the inside of the rotor casing 53. As a result, the lubricating oil used in the bearing 56 placed inside the rotor casing 53 or the oil used in the disk motor 50 will not leak through the flow paths 166A, 166B, and 166C into the optical disk device.

Embodiment 2 describes the case where the three flow paths 166A, 166B, and 166C are formed in the optical-disk-facing surface 52 of the rotor casing 53. However, the invention is not limited to this example, and there may be any number of flow paths, even just one will do. These flow paths may be formed at arbitrary positions as long as they extend from the outer circumference of the optical-disk-facing surface 52 toward the restraining element 70 and allow the air inside the optical disk device to flow through.

Embodiment 2 also describes the case where the side wall 167 is inclined relative to the normal line NL₃ and curved while the side wall 168 is inclined relative to the normal line NL₄ and curved. However, the invention is not limited to this example, and the side walls 167 and 168 may be flat, not curved, and inclined to the normal lines NL₃ and NL₄. Also, the shape of the flow paths is not particularly limited as long as each flow path extends from the outer circumference of the optical-disk-facing surface 52 toward the restraining portion 70 and allows the air to flow through.

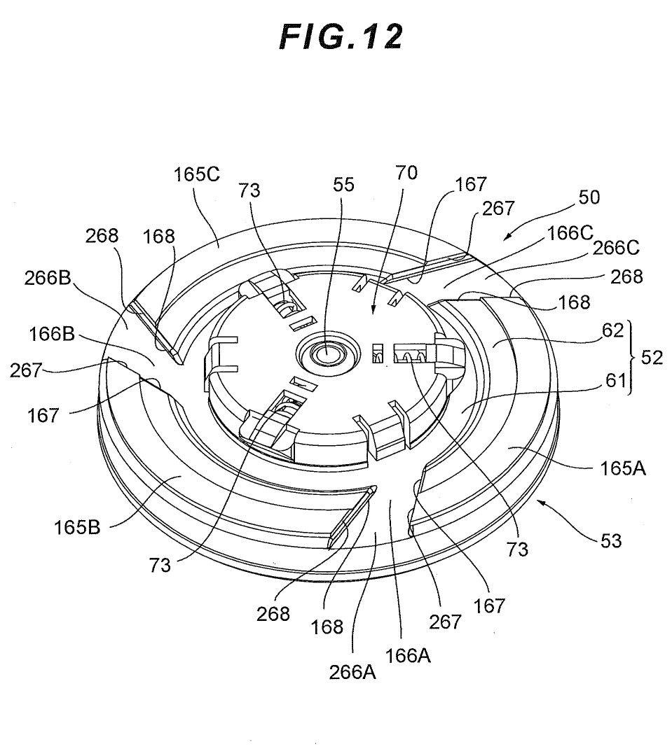

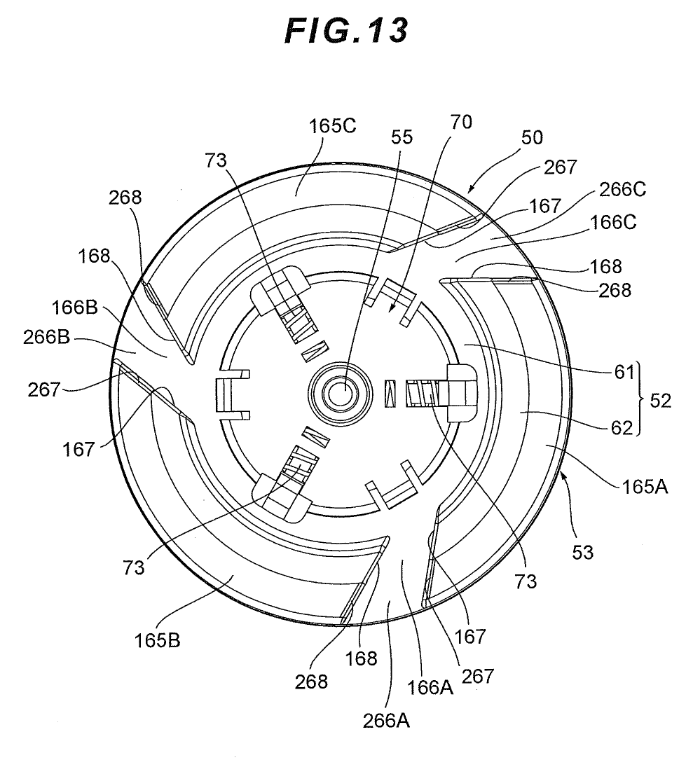

Furthermore, Embodiment 2 describes the case where the ring-shaped supporting element 165 is provided. However, the invention is not limited to this example, and the supporting element 165 may be, for example, as shown in FIGS. 12 and 13, divided into three equal support sections 165A to 165C along the circumferential direction so that gaps are formed in the areas corresponding to the flow paths 166A, 166B, and 166C. These gaps serve as flow paths 266A, 266B, and 266C that overlap the flow paths 166A, 166B, and 166C respectively so that, when the optical disk 100 rotates, the air inside the optical disk device passes through the flow paths 166A, 166B, and 166C as well as the flow paths 266A, 266B, and 266C. As a result, it is possible to further enhance realization of uniform temperature and pressure distribution in the optical disk device.

In the structure shown in FIGS. 12 and 13, the side wall 267 on one side of each support section 165A to 165C that extends inwards from the outer circumference is inclined and curved in the same manner as the side wall 167 defining one side of each flow path 166A, 166B, and 166C that extends inwards from the outer circumference, while the side wall 268 on the other side of each support section 165A to 165C that extends inwards from the outer circumference is inclined and curved in the same manner as the side wall 168 defining the other side of each flow path 166A, 166B, and 166C that extends inwards from the outer circumference. In other words, the side wall 267 lies in the same plane with the side wall 167 while the side wall 268 lies in the same plane with the side wall 168.

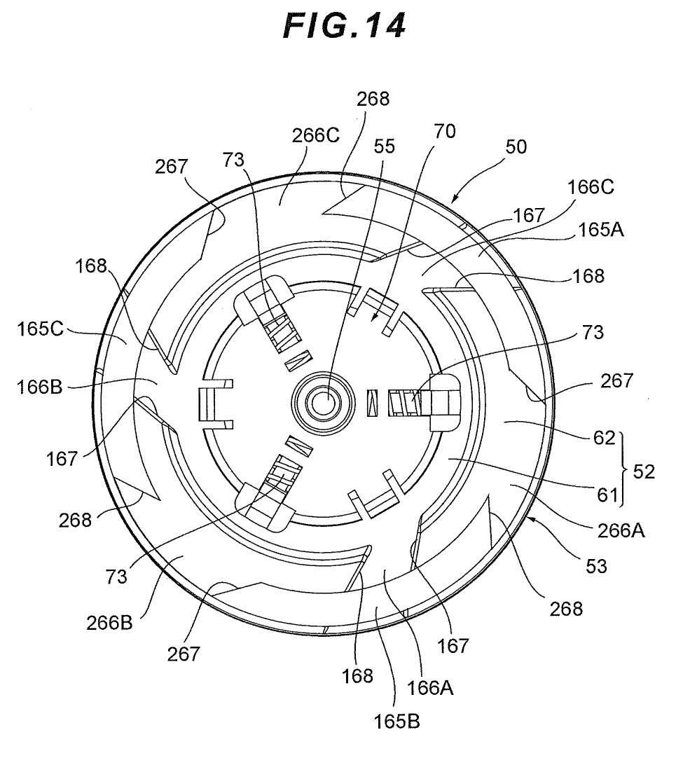

Alternatively, as shown in FIG. 14, the flow paths 266A, 266B, and 266C defined by the support sections 165A to 165C may be formed at positions shifted from those of the flow paths 166A, 166B, and 166C. Also with this arrangement of the flow paths 266A, 266B, and 266C, the air inside the optical disk device passes, just as in the above-described case, through the flow paths 166A, 166B, and 166C as well as the flow paths 266A, 266B, and 266C when the optical disk 100 rotates. As a result, it is possible to further enhance realization of uniform temperature and pressure distribution inside the optical disk device.

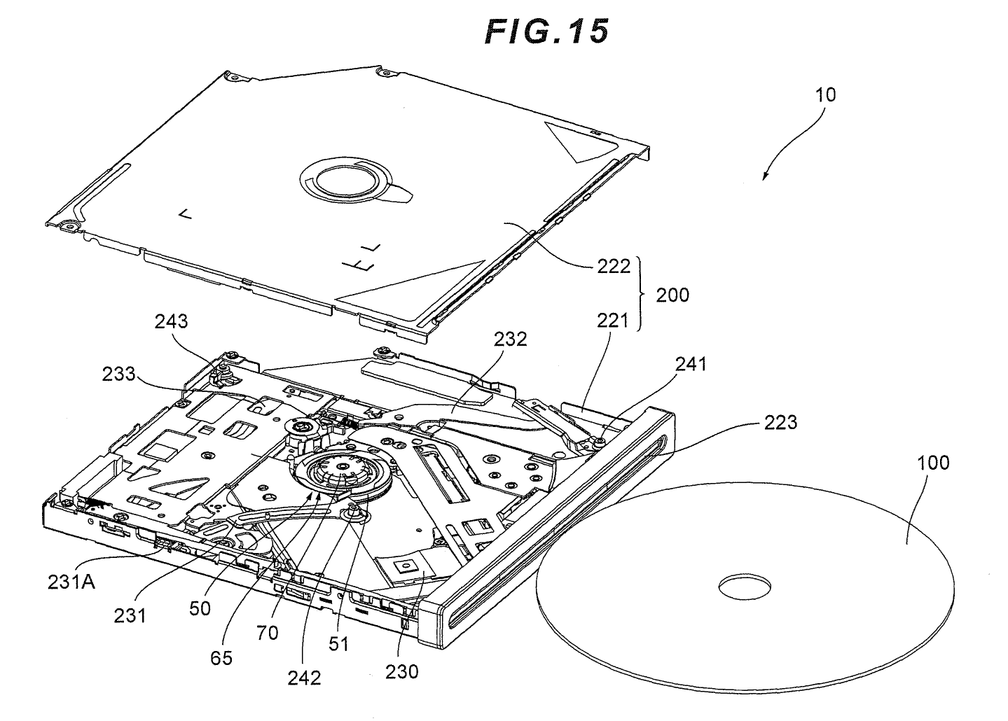

Embodiments 1 and 2 describe the type of optical disk device in which the tray 3 is placed in the housing 2, and the optical disk 100 is placed at a specified position on the tray 3 when ejected from the housing 2, and the tray 3 with the optical disk 100 mounted thereon is inserted back into the housing 2. However, the invention is not limited to this example, and the optical disk device according to the invention may be, for example, a slot-in type where the optical disk 100 is directly inserted into a housing 200 as shown in FIG. 15.

A slot-in type optical disk device 10 shown in FIG. 15 has a box-shaped housing 200 composed of a bottom casing 221 and a top casing 222 placed on the bottom casing 221. The disk motor 50, supporting element 65 (165), and restraining element 70 described above are placed on the approximately central portion of the bottom casing 221. Levers 231, 232, and 233 are also provided on the bottom casing 221, the levers serving as power sources for insertion and ejection of the optical disk 100 when the optical disk 100 is inserted into the housing 200 from an opening 223 formed in the front face of the housing 200, or ejected from the housing 200. The lever 231 rotates around a fulcrum 231A. Rollers 241, 242, and 243 are for centering the optical disk 100 by contact with the outer circumference of the optical disk 100 when inserted. Note that reference numeral “230” represents the optical pickup.

In the optical disk device 10 having the above structure, when the optical disk 100 is directly inserted into the housing 200 from its opening 223, the rollers 241, 242, and 243 come into contact, in that order, with the outer circumference of the optical disk 100, change the positions of the levers 231, 232, and 233, and perform centering of the optical disk 100, so that the optical disk 100 is positioned so as to be generally concentric with the drive shaft of the disk motor 50.

Just like the optical disk devices described earlier, this slot-in type optical disk device 10 can also make the air flow inside the optical disk device 10 through the flow paths 66A, 66B, and 66C (166A, 166B, 166C; and 266A, 266B, 266C) during the rotation of the optical disk 100, and further enhance realization of uniform temperature and pressure distribution in the optical disk device 10.

Incidentally, the thickness of the housing 200 (thickness in a direction generally perpendicular to the optical disk surface 101 of the optical disk 100 rotated by the disk motor 50) is not particularly limited. The housing 200 may have a thickness between 5 mm and 15 mm inclusive (for example, 9.5 mm or 12.7 mm), or may have a thickness outside the above-mentioned range.

As explained above, when the optical disk rotates, the optical disk device according to an aspect of the invention allows the air to flow from the space between the optical disk and the rotor casing, via the flow paths formed in the supporting element, to the central portion of the optical disk, and is thereby able to realize uniform temperature and pressure distribution in the optical disk device. Because the flow paths are formed in the supporting element, the air can be prevented from passing through the inside of the rotor casing, and the lubricating oil used in the bearing placed inside the rotor casing and the oil used in the disk motor will not leak via the flow paths. Consequently, a high-precision and highly-reliable optical disk device can be provided.

Moreover, when the optical disk rotates, the optical disk device according to another aspect of the invention allows the air to flow from the space between the optical disk and the rotor casing, via the first flow paths formed on the optical-disk-facing surface of the rotor casing, to the central portion of the optical disk, and is thereby able to realize uniform temperature and pressure distribution in the optical disk device. Furthermore, because the first flow paths are formed on the optical-disk-facing surface of the rotor casing, the air can be prevented from passing through the inside of the rotor casing, and the lubricating oil used in the bearing placed inside the rotor casing or the oil used in the disk motor will not leak via the flow paths. Consequently, a high-precision and highly-reliable optical disk device can be provided.

According to the present invention, a highly-reliable optical disk device can be provided.

I (We) claim:

1. An optical disk device having a disk motor for rotating an optical disk on which information is recorded or from which information is reproduced,
wherein the disk motor has a rotor located so as to be concentric with the optical disk rotated by the disk motor;
the rotor includes a rotor casing having an optical-disk-facing surface opposite an optical disk surface of the optical disk rotated by the disk motor;
a restraining element to be inserted into a center hole in the optical disk for restraining movement of the optical disk in its radial direction is located on a central portion of the optical-disk-facing surface, and a supporting element for supporting the optical disk surface is placed on a radially outer portion of the optical-disk-facing surface;
the supporting element has at least one flow path extending from the outer circumference of the supporting element to its inner circumference to allow the air inside the optical disk device to flow through; and
the restraining element has at least one through-hole connected to the flow path, and at least one flow hole for allowing the air to flow between the inside and outside of the restraining element.

2. The optical disk device according to claim 1, wherein the supporting element is divided into a plurality of support sections at specified positions along the circumferential direction of the rotor, and the flow path is a gap formed between the adjacent support sections.

3. The optical disk device according to claim 2, wherein side walls of each support section are two sides of the support section that extend inwards from its outer circumference; and the side walls, opposite each other, of adjacent support sections define the gap; and each side wall is inclined relative to a normal line passing through an outer circumferential edge of that side wall so that an inner circumferential edge of that side wall is positioned behind the normal line relative to a rotational direction of the optical disk.

4. The optical disk device according to claim 3, wherein, of the side walls of each support section that extend inwards from its outer circumference, the side wall positioned at the front, relative to the rotational direction of the optical disk, is curved inwards, while the side wall positioned at the back, relative to the rotational direction of the optical disk, is curved outwards.

5. The optical disk device according to claim 1, wherein the flow paths are of generally the same shape.

6. The optical disk device according to claim 5, wherein the flow paths are located at regular intervals around the circumference of the rotor.

7. An optical disk device having a disk motor for rotating an optical disk on which information is recorded or from which information is reproduced,
wherein the disk motor has a rotor located so as to be concentric with the optical disk rotated by the disk motor;
the rotor includes a rotor casing having an optical-disk-facing surface opposite an optical disk surface of the optical disk rotated by the disk motor;
a restraining element to be inserted into a center hole in the optical disk for restraining movement of the optical disk in its radial direction is located on a central portion of the optical-disk-facing surface, and a supporting element for supporting the optical disk surface is placed on a radially outer portion of the optical-disk-facing surface;
the rotor casing has, on the optical-disk-facing surface, at least one first flow path extending from the outer circumference of the rotor casing to the restraining element to allow the air inside the optical disk device to flow through; and
the restraining element has at least one through-hole connected to the first flow path, and at least one flow hole for allowing the air to flow between the inside and outside of the restraining element.

8. The optical disk device according to clam 7, wherein the first flow path is a recess formed in the rotor casing.

9. The optical disk device according to claim 8, wherein the recess is defined by side walls that extend inwards from the outer circumference of the rotor casing, and each of the side walls is inclined relative to a normal line passing through an outer circumferential edge of that side wall so that the other edge of that side wall closer to the restraining element is positioned behind the normal line relative to a rotation direction of the optical disk.

10. The optical disk device according to claim 9, wherein, of the side walls defining the recess that extend inwards from the outer circumference of the rotor casing, the side wall positioned at the front, relative to the rotational direction of the optical disk, is curved inwards, while the side wall positioned at the back, relative to the rotational direction of the optical disk, is curved outwards.

11. The optical disk device according to claim 7, wherein the first flow paths are of generally the same shape.

12. The optical disk device according to claim 11, wherein the first flow paths are located at regular intervals around the circumference of the rotor.

13. The optical disk device according to claim 7, wherein the supporting element has at least one second flow path extending from the outer circumference of the supporting element to its inner circumference to allow the air inside the optical disk device to flow through, and
the through-hole formed in the restraining element is connected to the first flow path and the second flow path.

14. The optical disk device according to claim 13, wherein the supporting element is divided into a plurality of support sections at specified positions along the circumferential direction of the rotor, and the second flow path is a gap formed between the adjacent support sections.

15. The optical disk device according to claim 14, wherein side walls of each support section are two sides of the support section that extend inwards from its outer circumference; and the side walls, facing opposite each other, of the adjacent support sections define the gap; and each side wall is inclined relative to a normal line passing through an outer circumferential edge of that side wall so that an inner circumferential edge of that side wall is positioned behind the normal line relative to a rotational direction of the optical disk.

16. The optical disk device according to claim 15, wherein, of the side walls of each support section that extend inwards from its outer circumference, the side wall positioned at the front, relative to the rotational direction of the optical disk, is curved inwards, while the side wall positioned at the back, relative to the rotational direction of the optical disk, is curved outwards.

17. The optical disk device according to claim 13, wherein the second flow paths are of generally the same shape.

18. The optical disk device according to claim 17, wherein the second flow paths are located at regular intervals around the circumference of the rotor.

19. The optical disk device according to claim 13, wherein the first flow path is connected to the second flow path.

20. The optical disk device according to claim 19, wherein one of the side walls that are two sides defining the recess and extending inwards from the outer circumference of the rotor casing, lies in the same plane with one of the side walls that are two sides of the support section extending inwards from its outer circumference, and the other side wall defining the recess lies in the same plane with the other side wall of the support section.

21. The optical disk device according to claim 1, further comprising a housing and a tray placed in the housing so that the tray can be inserted into or ejected from the housing, wherein the rotor is mounted on the tray.

22. The optical disk device according to claim 1, further comprising a housing and a base placed in the housing to support the optical disk inserted into the housing so that the optical disk is chucked by the rotor, wherein the rotor is mounted on the base.

23. The optical disk device according to claim 1, wherein the thickness of the optical disk device, in a direction generally perpendicular to the optical disk surface of the optical disk rotated by the disk motor, is between 5 mm and 15 mm inclusive.
